(19) United States
(12) Patent Application Publication
(10) Pub. No.: US 2006/0068121 A1
(43) Pub. Date: Mar. 30, 2006

(54) Apparatus for treating thin film and method of treating thin film

(75) Inventors: Jong-Chul Lee, Gyeongsan-si (KR); Soung-Yeoul Eom, Gumi-si (KR); Sang-Hyuck Park, Osan-si (KR)

Correspondence Address: BRINKS HOFER GILSON & LIONE, P.O. BOX 10395, CHICAGO, IL, 60610, US

(73) Assignee: LG PHILIPS LCD CO., LTD.

(21) Appl. No.: 11/221,007

(22) Filed: Aug. 24, 2005

(30) Foreign Application Priority Data
Aug. 27, 2004 (KR) 2004-0067917

(51) Int. Cl. B05D 3/00; B29C 71/04; B44C 1/22

(52) U.S. Cl. 427/532; 118/723 R; 216/63

(57) ABSTRACT

An apparatus for treating a thin film on a substrate includes a stage on which the substrate is disposed. A gas shield faces the substrate. An energy source irradiates a part of the substrate with light emitted therefrom through a retention space of the gas shield. A dispense unit includes a pin nozzle that injects a reaction gas towards the part of the substrate.

The present invention claims benefit of Korean Patent Application No. P2004-0067917, filed in Korea on Aug. 27, 2004, which is hereby incorporated by reference.

### BACKGROUND OF THE INVENTION

1. Field of the Invention

The present invention relates to an apparatus for treating a thin film and a method of treating a thin film.

2. Background of the Related Art

Until recently, display devices have typically used cathode-ray tubes (CRTs). Presently, much effort is being expended to study and develop various types of flat panel displays, such as liquid crystal display (LCD) devices, plasma display panels (PDPs), field emission displays, and electro-luminescence displays (ELDs), as a substitute for CRTs.

These flat panel displays have a light emitting layer or a light polarizing layer on at least one transparent substrate. Recently, an active matrix type flat panel display, where a plurality of thin film transistors (TFTs) are arranged in a matrix manner, has become widely used due to high resolution and high ability of displaying moving images.

The flat panel display includes multiple thin films. Accordingly, the flat panel display is fabricated through the repetition of thin film-depositing process and thin film-etching process. A thin film-treating process such as a depositing process and an etching process is conducted in a chamber type thin film treatment apparatus having an airtight reaction area.

FIG. 1 is a cross-sectional view of a chamber type thin film-treating apparatus for a flat panel display according to the related art.

As shown in FIG. 1, in a chamber type thin film-treating apparatus, a chamber 10 defines a reaction space “A”, and a substrate 2 is disposed therein. A reaction gas flows in the reaction space “A”, then it is activated, and thus a thin film-treating process is conducted. To activate the reaction gas and increase the process rate, reaction conditions such as high temperature and vacuum are produced or a plasma along with such the reaction conditions is generated. The apparatus of FIG. 1 is a plasma enhanced chemical vapor deposition (PECVD) apparatus. In the PEVCD apparatus, a thin film-depositing process is conducted with the reaction gas activated into plasma state by using radio frequency (RF) voltage.

To conduct this process, upper and lower electrode portions 20 and 30 facing each other are disposed in the chamber 10, and the substrate 2 is disposed between the upper and lower electrode portions 20 and 30. The upper electrode portion 20 includes a backing plate 22 and a showerhead plate 24 below the backing plate 22. The backing plate 22 is supplied with high voltage of radio frequency (RF) and thus acts as one electrode to generate and maintain plasma. The showerhead plate 24 has a plurality of injection holes 26 to inject external reaction gas into the reaction space “A”. The injection holes 26 are disposed entirely in the showerhead plate 24 and are open up and down. The lower electrode portion 30 includes a susceptor 32 and moves upward and downward with a moving assembly 34. The susceptor 32 acts as a chuck to support the substrate 2 and the other electrode to generate and maintain plasma.

A plurality of exhaust ports 14 are disposed along a peripheral portion of a bottom surface of a chamber 10 to exhaust gases in the reaction space “A” with an external aspirator system (not shown).

The substrate 2 is transferred into the chamber 10 and placed on the susceptor 32, and then the moving assembly moves up such that the substrate 2 faces the showerhead plate 24 with a predetermined distance. Then, the backing plate 22 is supplied with high voltage of radio frequency (RF) and the reaction gas is injected through the injection holes 26. Accordingly, the reaction gas is activated in the reaction space “A” and thus plasma is generated and maintained, thereby a thin film deposited on the substrate 2.

As explained above, the chamber type thin film-treating apparatus uses the chamber 10 defining the airtight reaction space “A” where the substrate 2 is loaded, and the reaction gas is activated with adequate means to conduct the corresponding process.

However, large sized substrates are problematic for the chamber type apparatus. In other words, a size of the flat panel display recently has increased, and the substrate 2 is used as a bare or mother substrate, which is cut by cell constituting the flat panel display, in order to improve fabrication efficiency. For example, the substrate 2 has a size of about several square meters (m²). Accordingly, to load the large-sized substrate 2, a size of the chamber 10 increases in accordance to a size of the substrate 2. Correspondingly, the space occupied by the chamber type apparatus increases.

To solve these problems, a gas shield type thin film-treating apparatus has been suggested. FIG. 2 is a cross-sectional view of a gas shield type thin film-treating apparatus according to the related art.

As shown in FIG. 2, a gas shield type thin film-treating apparatus uses laser-induced chemical vapor deposition method. In other words, thin film treatment is conducted using light to irradiate a part of a substrate 2 and a reaction gas supplied to the irradiated part of the substrate 2 under atmospheric pressure.

The gas shield type apparatus includes a stage 50 where the substrate 2 is placed, a gas shield 60 over the stage 50, and an energy source 72 over the gas shield 60.

The stage 50 moves up/down and left/right i.e., horizontally and vertically. The gas shield 60 has a retention space 62, which is open up and down, disposed at a center portion of the gas shield 60 corresponding to the energy source 72. The upper open portion of the retention space 62 is shielded by a transparent window 64. A laser beam irradiates a part of the substrate 2 through the transparent window 64 and the retention space 62. An external reaction gas supplied to the retention space 62 flows into the irradiated part of the substrate 2. A plurality of exhaust grooves 68 are disposed at a rear surface of the gas shield 60 facing the substrate 2 to exhaust the residual reaction gas on the substrate 2. A gas supply path 66 is connected to the retention space 62 to supply the reaction gas. A gas exhaust path 70 is connected to the exhaust grooves 68 to exhaust the residual reaction gas outside.

The substrate 2 is placed on the stage 50, and the stage 50 moves to be aligned with the gas shield 60 and the energy source 72. Then, a laser beam from the energy source 72 irradiates a part of the substrate 2 and the reaction gas is supplied to the retention space 62. The reaction gas is activated by the laser beam, and thus a thin film-treating process such as depositing or etching is conducted at the irradiated part of the substrate 2. The thin film-treating process is conducted along a continuous line by movement of the stage 50.

However, the related art gas shield type thin film-treating apparatus has problems related to uniformity of the thin film. Since the thin film-treating process is conducted under atmospheric pressure, much of the reaction gas is not used to treat the thin film and exhausted, thus increasing production loss. It is also difficult to supply and exhaust the reaction gas stably. Thus, reducing the process rate. In the gas shield type thin film-treating apparatus, since the thin film-treating process is conducted under atmospheric pressure, maintaining constant pressure for supplying and exhausting the reaction gas is problematic compared with the chamber type thin film-treating apparatus, thus deteriorating uniformity of the thin film.

Further, due to the above-explained reason, the moving speed of the stage is limited and thus the process rate is reduced. For example, when a repairing process to connect a broken thin film pattern is conducted with the related art thin film-treating apparatus, the irradiating range of the laser beam, i.e. the focusing area is about 300 μm² while the moving speed of the stage is about 3 to 10 μm/sec. Accordingly, the total process time for one substrate, i.e. a total around cycle time (TACT), is large.

Further, the related art gas shield type thin film-treating apparatus has a large-sized stage moved according to a large-sized the substrate. The thin film-treating apparatus has complex structures and impurities such as particles are generated. Thus, the substrate may become contaminated, and purity and uniformity of the thin film are deteriorated.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention. In the drawings:

FIG. 1 is a cross-sectional view of a chamber type thin film-treating apparatus for a flat panel display according to the related art;

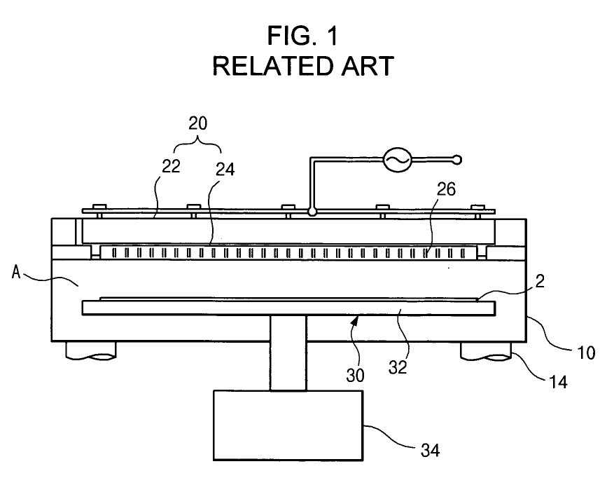

FIG. 2 is a cross-sectional view of a gas shield type thin film-treating apparatus according to the related art;

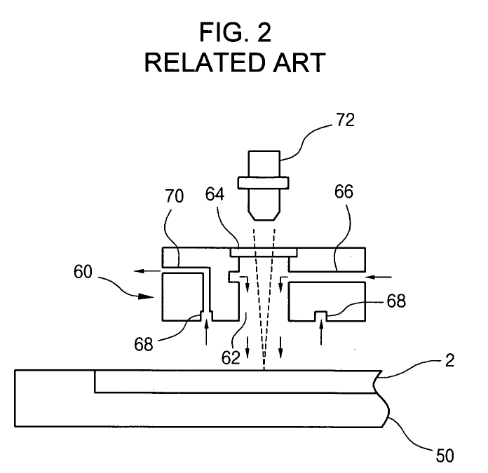

FIG. 3 is a cross-sectional view of a gas shield type thin film-treating apparatus according to an embodiment of the present invention;

FIG. 4 is a cross-sectional view of a gas shield and a dispense unit of a gas shield type thin film-treating apparatus according to the embodiment of the present invention;

FIG. 5 is a perspective view of a rear surface of a gas shield of a gas shield type thin film-treating apparatus according to the embodiment of the present invention;

FIGS. 6A and 6B are schematic plan views illustrating a rotation of a gas shield according to the embodiment of the present invention.

### DETAILED DESCRIPTION OF THE PREFERRED EMBODIMENTS

Reference will now be made in detail to the illustrated embodiments of the present invention, which are illustrated in the accompanying drawings.

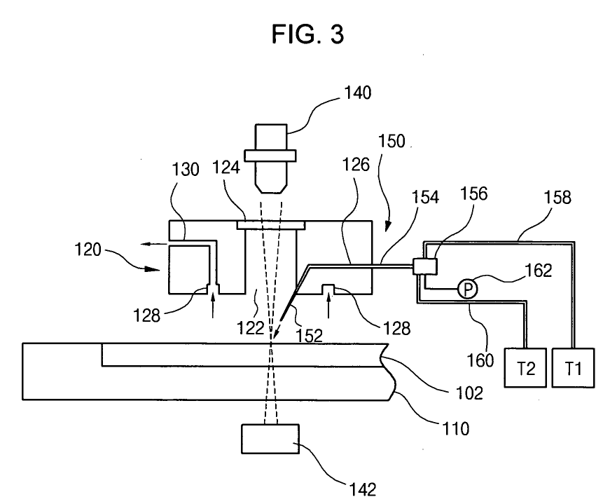

FIG. 3 is a cross-sectional view of a gas shield type thin film-treating apparatus according to an embodiment of the present invention. The thin film-treating apparatus according to the embodiment of the present invention is applicable not only to flat panel displays but also to devices including thin films such as semiconductor devices. The process of treating a thin film includes processes related to forming a thin film on a substrate such as depositing, etching and the like.

As shown in FIG. 3, the thin film-treating apparatus includes a stage 110 on which a substrate 102 is disposed, a gas shield 120 disposed over and facing the substrate 102, and an energy source 140 over the gas shield 120.

The stage 110 may be fixed, and the substrate 102 thereon may be referred to a large-sized bare or mother substrate which is cut into multiple pieces (cells) in a scribing process.

The gas shield 120 is spaced apart from the substrate 102 by several micrometers to several hundred micrometers. The gas shield 120 may be made of aluminum (Al) and have a circle-banded shape or a polygon-banded shape. A retention space 122 is disposed at a center portion of the gas shield 120. The retention space 122 is open up and down, and upper open portion of the retention space 122 is shielded by a transparent window 124. The transparent window 124 may be made of quartz. A plurality of exhaust grooves 128 are disposed in a rear surface of the gas shield 120. The exhaust grooves 128 are connected to a gas exhaust path 130 and are connected to each other through the gas exhaust path 130. An exterior aspirator system such as a vacuum pump is connected to the gas exhaust path 130. Accordingly, the exterior aspirator system exhausts a reaction gas through the exhaust grooves 128 and the gas exhaust path 130.

The energy source 140 is disposed over and corresponds to the transparent window 124. The energy source 140 generates light that irradiates a part of the substrate 102 through the transparent window 124 and the retention space 122. A laser beam, ultra violet (UV) ray, radio frequency (RF) ray or u-wave ray may be used as the light. The wavelength and intensity of the light may be fixed or adjustable. Also, a range of irradiation of the light may be controlled by using a slit (not shown).

In the embodiment shown, the gas shield 120 along with the energy source 140 moves up/down and left/right i.e., horizontally and vertically to the substrate 102 and the stage 110 is fixed. Accordingly, the gas shield type apparatus shown can be operated with low power and have simple structures, and generation of particles can be reduced, as compared with the related art.

In addition, the gas shield 120 and the energy source 140 may move relative to the stage 110. In other words, the gas shield 120 and the energy source 140 may be fixed and the stage 110 may move, or the gas shield 120 and the energy source 140 may move and the stage 110 may move.

Further, in the embodiment shown, the reaction gas is supplied directly to the irradiated part of the substrate 102 through a dispense unit 150.

The gas shield type thin film-treating apparatus according to the embodiment is explained in more detail with reference to FIGS. 3 to 5.

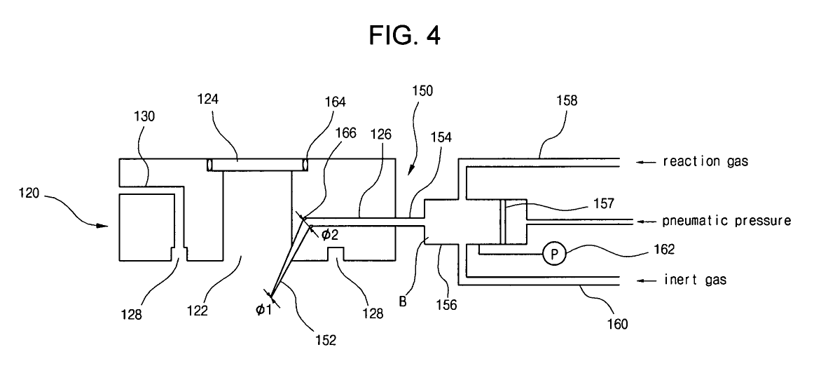

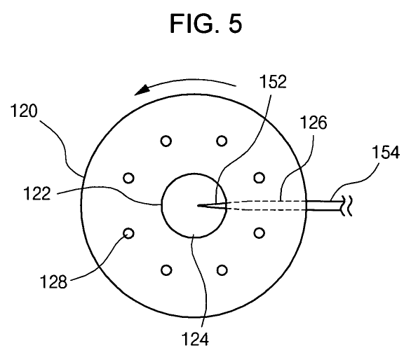

FIG. 4 is a cross-sectional view of a gas shield and a dispense unit of a gas shield type thin film-treating apparatus according to the embodiment of the present invention, and FIG. 5 is a perspective view of a rear surface of a gas shield of a gas shield type thin film-treating apparatus according to the embodiment of the present invention.

As shown in FIGS. 3 to 5, the gas shield 120 includes the retention space 122 at a center portion of the gas shield 120, the transparent window 124, and the exhaust holes 128 and the gas exhaust path 130 to exhaust the residual reaction gas on the substrate 102.

The dispense unit 150 is disposed to concentrically inject the reaction gas to the irradiated part of the substrate 102. The dispense unit 150 includes a pin nozzle 152 which is inserted inside the gas shield 120 and is projected into the irradiated part of the substrate 102.

The pin nozzle 152 branches off from an inner surface of the gas shield 120 surrounding the retention space 122 and may be made of ceramic material. The pin nozzle 152 has a taper shape such that diameter of the pin nozzle 152 tapers off from one end thereof disposed in the gas shield 120 to the other end thereof facing the substrate 102. The other end of the pin nozzle 152 may have a first diameter “φ1” of about 10 μm to 50 μm, and the one end of the pin nozzle 152 may have a second diameter “φ2” of about 100 μm to 500 μm. In one embodiment, a ratio of the second diameter to the first diameter may be about 10. The pin nozzle 152 extends from the gas shield 120 at an oblique angle relative to the stage 102. The other end of the pin nozzle 152 is more proximate to the stage 110 than the gas shield 120, and may be disposed substantially in a center of the retention space 122.

A gas supply path 126 is disposed in the gas shield 120 to supply the external reaction gas to the pin nozzle 152. The gas supply path 126 is connected to a first reservation tank “T1” storing the reaction gas.

As explained above, the gas shield type apparatus according to the embodiment of the present invention includes the dispense unit 150 which has the first reservation tank “T1” storing the reaction gas, the gas supply path 126 in the gas shield 120 supplying the reaction gas, and the pin nozzle 152 projected into the substrate 102 and concentrically injecting the reaction gas to the light-irradiated part of the substrate 102.

A first O-ring 166 is disposed at a connection portion between the gas supply path 126 and the pin nozzle 152. The first O-ring 166 acts as a sealing member to prevent the reaction gas leaking into an outside or the retention space 122. The first O-ring 166 may be made of a highly chemical-proof material that does not easily corrode when the first O-ring 166 is exposed to the reaction gas. For example, the first O-ring 166 may be made of a fluoro elastomer (FKM) having tolerance to the reaction gas, such as viton, karlez and chemrez.

When the substrate 102 is placed on the stage 110, both the gas shield 120 and the energy source 140 moves to be aligned with the substrate 102. Then, light is generated from the energy source 140, and the light irradiates a part of the substrate 102 through the transparent window 124 and the retention space 122. At the same time, the reaction gas stored in the first reservation tank “T1” is supplied to the pin nozzle 152 through the gas supply path 126, and the reaction gas supplied to the pin nozzle 152 is injected into the irradiated part of the substrate 102. The injected reaction gas is activated by the light to deposit a thin film or to etch a thin film previously deposited on the substrate 102.

Further, both the gas shield 120 and the energy source 140 moves and conducts a thin film-treating process along a continuous line. During the thin film-treating process, the residual reaction gas on the substrate 102 is continuously exhausted through the exhaust holes 128 and the gas exhaust path 130. The reaction gas from the pin nozzle 152 is injected toward a direction opposite to a moving direction of the gas shield 120 in order to treat the thin film uniformly. In other words, the reaction gas is injected opposite to a thin film-treating direction. To do this, the pin nozzle 152 is projected opposite to a moving direction of the gas shield 120.

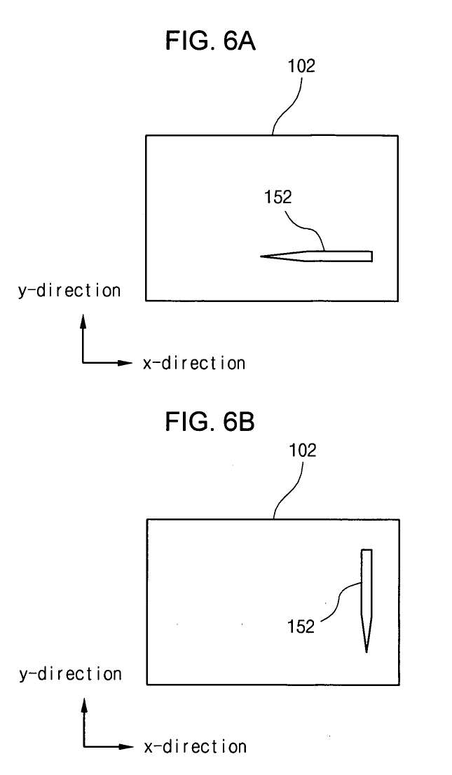

As above explained, the gas shield 120 moves along an x-direction and a y-direction horizontal to the substrate 102 in order to treat the thin film on the entire substrate 102. Also, the pin nozzle 152 injects the reaction gas opposite to a moving direction of the gas shield 120. Accordingly, the gas shield 120 may be rotated according to a change of a moving direction of the gas shield 120 in order to inject the reaction gas opposite to a moving direction of the gas shield 120. The gas shield 120 is rotated with respect to the retention space 122. Such rotation of the gas shield 120 is explained in more detail with reference to FIGS. 5, 6A and 6B.

FIGS. 6A and 6B is a schematic plan view illustrating a rotation of a gas shield according to the embodiment of the present invention. In FIGS. 6A and 6B, the pin nozzle and the substrate are shown in brevity of explanations.

As shown in FIGS. 5 and 6A, the gas shield 120 moves along a positive x-direction and conducts a thin film-treating process, and the pin nozzle 152 injects the reaction gas into the substrate 102 toward a negative x-direction. After the thin film-treating process along an x-direction is conducted, the gas shield 120 may change the moving direction by 90 degrees to conduct a thin film-treating process along a positive y-direction. When the moving direction is changed, the gas shield 120 is rotated by 90 degrees to inject the reaction gas toward a negative y-direction. In other words, a rotation angle of the gas shield 120 may correspond to a change angle of a moving direction of the gas shield 120.

A monitoring device 142 such as a charge coupled device (CCD) may be disposed below the stage 110. The monitoring device 142 displays a result of the thin film treatment in real-time such that abnormality of thin film treatment is perceived readily.

In the gas shield type apparatus according to the embodiment shown, since the light and the reaction gas is concentrically supplied to a part of the substrate 102, the process rate can be increased and the residual reaction gas can be minimized.

To maintain constant pressure of the reaction gas supplied and exhausted, which is closely related to uniformity of thin film treatment, the dispense unit 150 further includes a cylinder tank 156 interposed between the first reservation tank “T1” and the gas supply path 126, a pressure gauge 162 indicating an inner pressure of the cylinder tank 156 and a second reservation tank “T2” storing an inert gas supplied to the cylinder tank 156.

In more detail, the gas supply path 126 in the gas shield 120 is connected to the cylinder tank 156 through a first supply pipe 154. A buffer area “B” is defined in the cylinder tank 156. The buffer area “B” is connected to the first reservation tank “T1” through a second supply pipe 158. Also, the buffer area “B” is connected to the second reservation tank “T2” through a third supply pipe 160.

Accordingly, the reaction gas of the first reservation tank “T1” passes through the buffer area “B” of the cylinder tank 156, then supplies to the pin nozzle 152 through the first supply pipe 154 and the gas supply path 126, and then is injected into a part of the substrate 102. The inert gas of the second reservation tank “T2”, if necessary, is supplied to the buffer area “B” of the cylinder tank 156. In other words, the inert gas is used as a bulk gas adjusting a pressure and a concentration of the reaction gas. As the inert gas, argon (Ar), helium (He) and nitrogen gas (N₂) may be used.

Further, in the cylinder tank 156, a piston 157 may be disposed to adjust a pressure of the buffer area “B”. The piston 157 is operated to move forward and backward by pneumatic pressure such that a volume of the buffer area “B” is varied. Accordingly, the piston 157 adjusts a pressure of the reaction gas injected by the pin nozzle 152. For the pneumatic pressure, the inert gas of the second reservation tank “T2” may be used.

Since the pressure gauge 162 indicates the inner pressure of the buffer area “B”, a supplying amount of the inert gas from the second reservation tank “T2” and a moving range of the piston 157 can be adjusted readily. Accordingly, a pressure of the reaction gas injected by the pin nozzle 152 can be adjusted readily.

In other words, to increase the speed of the thin film-treating process, the pressure of the reaction gas increases, and, at the same time, a moving speed of the gas shield 120 and the energy source 140 increases. To decrease a speed of the thin film-treating process, the pressure of the reaction gas decreases, and, at the same time, the moving speed of the gas shield 120 and the energy source 140 decreases. In this manner, the speed of the thin film-treating process can be adjusted readily. Therefore, uniformity of thin film treatment can be obtained effectively. In other embodiments, the pressure of the reaction gas may increase while the speed of the gas shield and the energy source 140 decreases, or, the pressure of the reaction gas may decrease while the speed of the gas shield and the energy source 140 increases.

A second O-ring 164 may be disposed at a contact portion between the gas shield 120 and the transparent window 124. The second O-ring 164 surrounding a periphery of the transparent window 124 acts as a sealing member to prevent the reaction gas leaking into the outside, similar to the first O-ring 166. The second O-ring 164 may be made of the same material as the first O-ring 166, such as a fluoro elastomer (FKM).

In the above-explained embodiment, a thin film-depositing process and a thin film-etching process as a thin film treating process are mainly explained with the gas shield type thin film-treating apparatus. However, with the gas shield type thin film-treating apparatus, an insulator previously deposited on the substrate may be removed by using only light from the energy source without the reaction gas, and this removing process may be conducted prior to the thin film-treating process such that a thin film pattern under the insulator is exposed. Further, with the gas shield type thin film-treating apparatus, a repairing process to connect a broken thin film pattern or to break an abnormally electrically shorted thin film pattern may be conducted.

As explained above, in the gas shield type thin film-treating apparatus, regardless of the fact that thin film treatment is conducted under atmospheric pressure, the reaction gas can be supplied and exhausted stably, and unused exhausted reaction gas can be minimized. In other words, since the reaction gas is concentrically injected on a light-irradiated part of the substrate, most of the reaction gas is used for thin film treatment. Accordingly, uniformity of the thin film treatment can be obtained, the production loss can be minimized, and the process rate can be improved.

Further, by using the cylinder tank, a constant pressure of the reaction gas supplied and exhausted can be maintained easily. Accordingly, the process rate can be adjusted and uniform thin film treatment can be obtained. Additionally, the small-sized gas shield and energy source is movable. Accordingly, the gas shield type thin film-treating apparatus can have simple structures. Also, generation of particles can be reduced, and thus contamination of the substrate can be prevented and purity of the treated thin film can be improved. As a result, productivity can be greatly improved, and thus the devices including the thin film having high quality can be produced.

It will be apparent to those skilled in the art that various modifications and variations can be made in the apparatus for treating the thin film and the method of treating the thin film of the present invention without departing from the spirit or scope of the invention. For instance, the present invention may also be applied to other electronic or display devices. Thus, it is intended that the present invention cover the modifications and variations of this invention provided they come within the scope of the appended claims and their equivalents.

What is claimed is:

1. An apparatus for treating a substrate, comprising:
a stage adapted to receive the substrate;
a gas shield facing the substrate and having a retention space;
an energy source disposed such that light emitted therefrom irradiates a part of the substrate through the retention space; and
a dispense unit including a pin nozzle through which a reaction gas is injected towards the part of the substrate.

2. The apparatus according to claim 1, wherein the pin nozzle is inserted into the gas shield and has a taper shape such that one end of the pin nozzle in the gas shield has a first diameter and the other end of the pin nozzle facing the substrate has a second diameter less than the first diameter.

3. The apparatus according to claim 2, wherein the ratio of the first diameter to the second diameter is about 10.

4. The apparatus according to claim 2, wherein the first diameter is about 100 μm to 500 μm, and the second diameter is about 10 μm to 50 μm.

5. The apparatus according to claim 1, wherein the dispense unit further includes a first reservation tank storing the reaction gas, and a gas supply path in the gas shield and connecting the pin nozzle and the first reservation tank.

6. The apparatus according to claim 5, wherein the dispense unit further includes a cylinder tank interposed between the first reservation tank and the gas supply path, the cylinder tank having a buffer area to adjust a pressure of the reaction gas.

7. The apparatus according to claim 6, wherein the dispense unit further includes a piston in the cylinder tank, the piston moving to adjust the pressure of the reaction gas.

8. The apparatus according to claim 5, wherein the dispense unit further includes a second reservation tank storing an inert gas supplied to the cylinder tank to adjust the pressure of the reaction gas.

9. The apparatus according to claim 1, wherein the gas shield is movable along with the energy source.

10. The apparatus according to claim 9, wherein the gas shield is rotatable by an angle corresponding to an angle of change of a moving direction of the gas shield.

11. The apparatus according to claim 9, wherein an injection direction of the reaction gas is opposite to a moving direction of the gas shield.

12. The apparatus according to claim 9, wherein an injection pressure of the reaction gas increases as a moving speed of the gas shield increases, and an injection pressure of the reaction gas decreases as the moving speed of the gas shield decreases.

13. The apparatus according to claim 1, wherein the gas shield further includes a transparent window shielding an upper open portion of the retention space.

14. The apparatus according to claim 1, wherein the gas shield further includes a plurality of exhaust grooves in a surface facing the substrate, and a gas exhaust path in the gas shield connected to the exhaust grooves.

15. The apparatus according to claim 5, further comprising a sealing member at a connection portion between the pin nozzle and the gas supply path.

16. The apparatus according to claim 1, further comprising a monitoring device providing a result of the thin film treatment in real-time.

17. A method of treating a thin film on a substrate, comprising:
placing the substrate on a stage;
irradiating a part of the substrate with light from an energy source; and
injecting a reaction gas through a pin nozzle to the irradiated part of the substrate such that the reaction gas is activated by the light to treat the thin film.

18. The method according to claim 17, wherein the light irradiates the part of the substrate through a retention space of a gas shield.

19. The method according to claim 18, wherein the gas shield is movable along with the light source.

20. The method according to claim 19, further comprising rotating a moving direction of the gas shield to the substrate by a change angle and rotating the gas shield by an angle corresponding to the change angle.

21. The method according to claim 19, wherein an injection direction of the reaction gas is opposite to a moving direction of the gas shield.

22. The method according to claim 19, further comprising increasing an injection pressure of the reaction gas as a moving speed of the gas shield increases, and decreasing an injection pressure of the reaction gas as the moving speed of the gas shield decreases.

23. The method according to claim 17, further comprising adjusting an injection pressure of the reaction gas in a buffer area.

24. The method according to claim 23, wherein the injection pressure of the reaction gas is adjusted by moving a piston to vary a volume of the buffer area.

25. The method according to claim 23, wherein the injection pressure of the reaction gas is adjusted by supplying an inert gas to the buffer area.

26. The method according to claim 17, further comprising exhausting the residual reaction gas.

27. The method according to claim 17, further comprising providing a result of the thin film treatment in real-time.

28. An apparatus for treating a substrate, comprising:
a stage adapted to receive the substrate;
a gas shield facing the stage and having a retention space;
an energy source disposed such that light emitted therefrom radiates towards a part of the stage through the retention space; and
a dispense unit adapted to inject a reaction gas toward the part of the stage, the dispense unit containing a gas supply path and an injection port, the injection port extending from the gas shield towards the stage and having an end with a cross-sectional area substantially smaller than that of the gas supply path.

29. The apparatus according to claim 28, wherein the injection port extends from the gas shield towards the stage at an oblique angle relative to the stage.

30. The apparatus according to claim 28, wherein the dispense unit further includes a first reservation tank storing the reaction gas, the gas supply path connecting the injection port and the first reservation tank.

31. The apparatus according to claim 30, wherein the dispense unit further includes a cylinder tank interposed between the first reservation tank and the gas supply path, the cylinder tank having a buffer area to adjust a pressure of the reaction gas.

32. The apparatus according to claim 31, wherein the dispense unit further includes a piston in the cylinder tank, the piston moving to adjust the pressure of the reaction gas.

33. The apparatus according to claim 30, wherein the dispense unit further includes a second reservation tank storing an inert gas supplied to the cylinder tank to adjust the pressure of the reaction gas.

34. The apparatus according to claim 28, wherein the gas shield is movable along with the energy source.

35. The apparatus according to claim 34, wherein the gas shield is rotatable by an angle corresponding to an angle of change of a moving direction of the gas shield.

36. The apparatus according to claim 34, wherein an injection direction of the reaction gas is opposite to a moving direction of the gas shield.

37. The apparatus according to claim 34, wherein an injection pressure of the reaction gas increases as a moving speed of the gas shield increases, and an injection pressure of the reaction gas decreases as the moving speed of the gas shield decreases.

38. The apparatus according to claim 28, wherein the gas shield further includes a transparent window shielding an upper open portion of the retention space.

39. The apparatus according to claim 28, wherein the gas shield further includes a plurality of exhaust grooves in a surface facing the stage, and a gas exhaust path in the gas shield connected to the exhaust grooves.

40. The apparatus according to claim 28, further comprising a sealing member at a connection portion between the injection port and the gas supply path.

41. The apparatus according to claim 28, further comprising a monitoring device disposed under the stage.

42. The apparatus according to claim 28, wherein the end of the injection port is more proximate to the stage than the gas shield.

43. The apparatus according to claim 28, wherein the end of the injection port is disposed substantially in a center of the retention space.
